(19) United States
(12) Patent Application Publication
(10) Pub. No.: US 2008/0190313 A1
(43) Pub. Date: Aug. 14, 2008

(54) PRINTING APPARATUS, READING APPARATUS, AND MOTOR COMPONENT MANAGEMENT SYSTEM AND METHOD USING THE SAME

(75) Inventors: Atsushi MUKAI, Kyoto (JP); Kanji KUBO, Kyoto (JP); Tsutomu FURUKAWA, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 12/027,414

(22) Filed: Feb. 7, 2008

(30) Foreign Application Priority Data
Feb. 8, 2007 (JP) 2007-028731

(51) Int. Cl. B41F 17/00

(52) U.S. Cl. 101/485

(57) ABSTRACT

A method for managing motor components is performed such that, while one of the motor components is held, identifying information, such as a two-dimensional code, for example, is printed on a printable region on a metal surface of the motor component by discharging ink from a printing head toward the printable region and relatively displacing a position at which the ink reaches within the printable region by moving one of the motor component and the printing head relative to the other. Then, the identifying information on the motor component is read. The identifying information that has been read is stored for each of the motor components. Based on the stored identifying information, the motor components are managed.

### BACKGROUND OF THE INVENTION

1. Field of the Invention

The present invention relates to a motor component management system and method. More particularly, the present invention relates to a printing apparatus which can print on motor components identifying information for identifying individual motor components, a reading apparatus which can read the identifying information printed on the motor components, and a component management method and system which uses the printing apparatus and the reading apparatus and manages the motor components.

2. Description of the Related Art

Disk drives, e.g., hard-disk drives, include a spindle motor (hereinafter, simply referred to as “motor”) for spinning disks which can store data therein. The motor for use in the disk drives includes a rotor assembly on which at least one disk is mounted and which rotates with the disk; a stationary assembly; and a bearing which supports the rotor assembly to be rotatable relative to the stationary assembly. An exemplary bearing is a hydrodynamic pressure bearing which uses a hydrodynamic pressure of lubricant retained in the bearing.

Demands for management of motor components by individually identifying them have been recently increased for the purpose of improving the productivity in manufacturing and quality control of the aforementioned motors. In order to meet those demands, a technique is proposed for identifying a plurality of bearings based on lot numbers or the like each recorded on an RFID (radio frequency identification) tag attached into a concave portion additionally formed on a housing bottom of each bearing (see Japanese Unexamined Patent Publications Nos. 2006-52782 and 2006-52783, for example).

The aforementioned technique, however, requires additional steps of forming the concave portion in the housing of the bearing and sealing the RFID tag into the concave portion with adhesive, for example, thus lowering the productivity in manufacturing of the motors. Moreover, it is difficult to form the concave portion for accommodating the RFID tag therein in small motors. This means that the aforementioned technique using the RFID tag cannot be applied to the small motors. In addition, the use of RFID tag increases the cost of the motors. Furthermore, environments in which the RFID tags can be used are limited or the RFID tags may be sensitive to environmental changes. Thus, the method steps which are required to be performed for the bearings to have the RFID tags embedded therein and the special handling of those bearings may be restricted.

### SUMMARY OF THE INVENTION

According to a preferred embodiment of the present invention, a method for printing identifying information on a motor component having a metal surface is provided. In the method, while the motor component is being held, ink is discharged from a printing head toward a printable region arranged on the metal surface of the motor component. A position at which the ink reaches is displaced within the printable region by moving at least one of the motor component and the printing head.

The discharge of the ink and the relative displacement of the position may be repeated until the identifying information is entirely printed on the printable region.

The method is suitable especially to motor components having a curved metal surface. The identifying information preferably is a two-dimensional code, for example.

According to another preferred embodiment of the present invention, a method for printing identifying information on a motor component having a metal surface is provided. In the method, while the motor component is being held, light is emitted from a head to a printable region arranged on the metal surface of the motor component. A position at which the light reaches is relatively displaced within the printable region by moving at least one of the motor component and the head.

The discharge of the ink and the relative displacement of the position may be repeated until the identifying information is entirely printed on the printable region.

The method is suitable especially to motor components having a curved metal surface. The identifying information preferably is a two-dimensional code, for example.

According to still another preferred embodiment of the present invention, a method for reading identifying information printed on a motor component having a metal surface is provided. In the method, while the motor component is being held, a printable region arranged on the metal surface of the motor component is irradiated with light from an oblique direction with respect to a normal to a center of the printable region. An image of the printable region is captured by an image-capturing device arranged such that a line connecting the center of the printable region to the image-capturing device is at an angle to the normal to the center of the printable region. The identifying information is acquired based on an output of the image-capturing device.

The light with which the printable region is irradiated may be emitted from a plurality of light sources arranged such that a line connecting the center of the printable region to each of the light sources is at an angle to the normal to the center of the printable region, and is then reflected by a reflecting portion toward the printable region. The light sources may be arranged about the image-capturing device over an entire circumference.

According to yet another preferred embodiment of the present invention, a method for managing a motor component having a metal surface is provided. In the managing method, while the motor component is being held, identifying information is printed on a printable region arranged on the metal surface of the motor component. The printing is carried out by discharging ink from a printing head toward the printable region and relatively displacing a position at which the ink reaches within the printable region by moving one of the motor component and the printing head relative to the other. Alternatively, the printing is carried out by irradiating the printable region with light from an oblique direction with respect to a normal to a center of the printable region and relatively displacing a position emitted by the light within the printable region by moving one of the motor component and a light source relative to the other. The identifying information on the motor component is read by any of the aforementioned method. The motor component is preferably cleaned prior to the printing of the identifying information.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a block diagram of a component management system according to a first preferred embodiment of the present invention.

FIG. 2 is a cross-sectional view of a motor.

FIG. 3 is a side view of a sleeve of the motor.

FIG. 4 illustrates a printing apparatus according to the first preferred embodiment of the present invention.

FIG. 5 illustrates a reading apparatus according to the first preferred embodiment of the present invention.

FIG. 6 is a plan view of the reading apparatus of FIG. 5.

FIG. 7 illustrates a reading apparatus of a component management system according to a second preferred embodiment of the present invention.

### DETAILED DESCRIPTION OF PREFERRED EMBODIMENTS

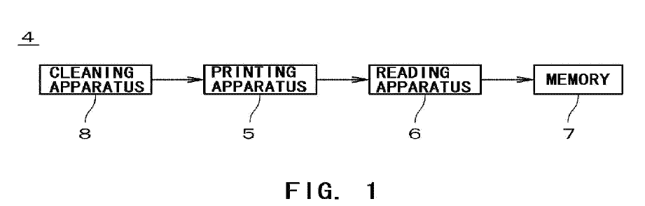

Referring to FIGS. 1 through 7, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to or substantially parallel to a center axis of a motor, and a radial direction indicates a direction perpendicular to or substantially perpendicular to the center axis.

### First Preferred Embodiment

FIG. 1 shows the configuration of a component management system 4 according to a first preferred embodiment of the present invention. The component management system 4 manages motor components and is installed in an assembly factory of motors, for example. In this preferred embodiment, the component management system 4 preferably is used for managing sleeves as a component of bearings of the motors, for example.

Referring to FIG. 1, the component management system 4 includes a printing apparatus 5 which prints identifying information such as at least one pattern or character on each motor component (sleeve in this preferred embodiment); a reading apparatus 6 which reads the identifying information printed on the motor component; a memory 7 which stores the identifying information read by the reading apparatus 6. The component management system 4 also includes a cleaning apparatus 8 which cleans each motor component before printing by the printing apparatus 5.

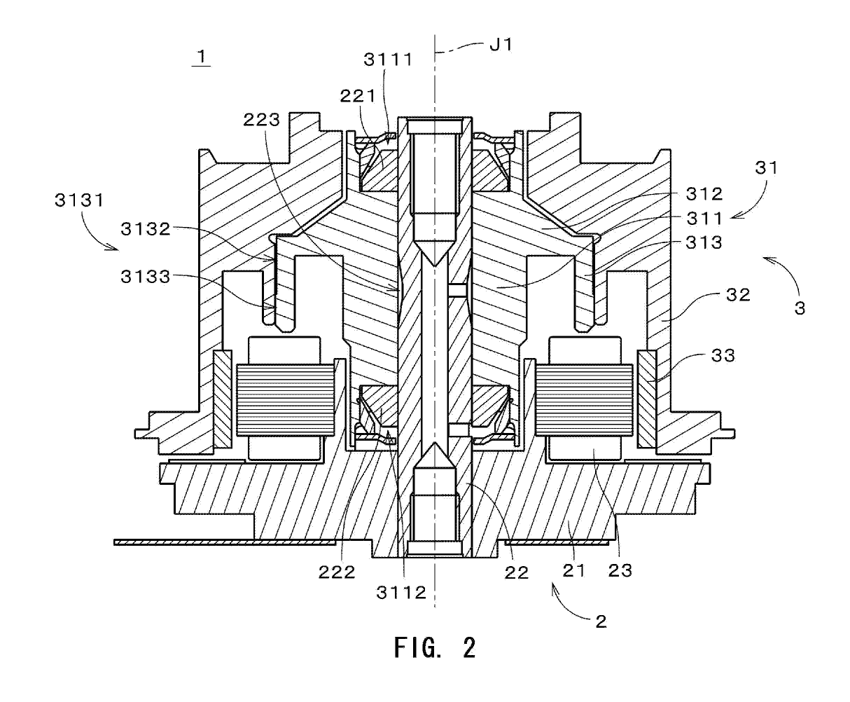

FIG. 2 is a cross-sectional view of an exemplary motor 1 including the motor component managed by the component management system 4. In this preferred embodiment, the motor 1 preferably is a spindle motor for use in a disk drive for spinning a disk.

As shown in FIG. 2, the motor 1 preferably is an outer rotor motor including a stationary portion 2 and a rotor portion 3. The rotor portion 3 is supported to be rotatable about a center axis J1 of the motor 1 relative to the stationary portion 2 via a bearing using a hydrodynamic pressure of lubricant. The center axis J1 serves as a center axis of a sleeve 31 described later. In the following description, the rotor portion 3 side and the stationary portion 2 side in an axial direction parallel to or substantially parallel to the center axis J1 are respectively referred to an upper side and a lower side for the sake of convenience. However, the center axis J1 is not necessarily parallel to a direction of gravity.

The stationary portion 2 includes a base portion 21 supporting other components of the stationary portion 2, a shaft 22 fixed to the base portion 21 and extending upward from the base portion 21, and an armature 23 fixed to the base portion 21 and surrounding the shaft 22. In this preferred embodiment, the shaft 22 is hollow and approximately cylindrical about the center axis J1. An upper projection 221 and a lower projection 222 are attached to an outer side surface of the shaft 22 in axially upper and lower regions, respectively. In this preferred embodiment, the upper and lower projections 221 and 222 are approximately annular about the center axis J1 when viewed along the axial direction.

The rotor portion 3 includes a sleeve 31 which accommodates the shaft 22 therein, a rotor hub 32 fixed to an outer side surface of the sleeve 31, and a field-generating magnet 33 fixed to the rotor hub 32 and generating a turning force or a torque centered on the center axis J1 together with the armature 23. A disk is mounted on the rotor hub 32. In this preferred embodiment, the sleeve 31 is hollow and approximately cylindrical. The sleeve 31 and the rotor hub 32 are preferably made of metal, for example, stainless steel.

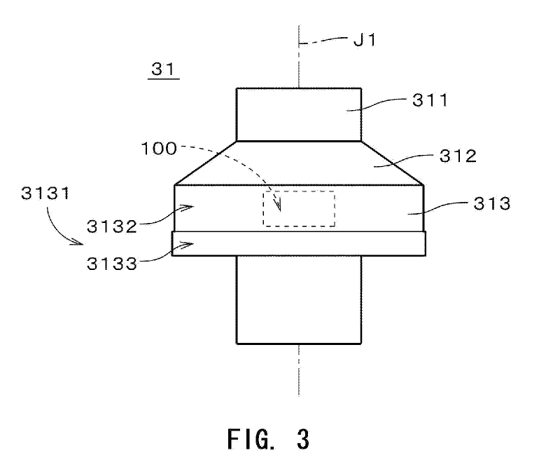

FIG. 3 is a side view of the sleeve 31. Referring to FIGS. 2 and 3, the sleeve 31 includes a shaft-insertion portion 311 which is hollow and can accommodate the shaft 31 therein, a flange portion 312 extending outwardly from an outer side surface of the shaft-insertion portion 311 in a radial direction perpendicular to or substantially perpendicular to the center axis J1, and a hub-fixing portion 313 which extends from an outer periphery of the flange portion 312 downward. To an outer side surface 3131 of the hub-fixing portion 313 is fixed the rotor hub 32. The hub-fixing portion 313 is approximately cylindrical.

Referring to FIG. 3, the outer side surface of the sleeve 31 is formed by a surface of rotation about the center axis J1 of the sleeve 31. An upper surface of the flange portion 312 is inclined with respect to the center axis J1. The outer side surface 3131 of the hub-fixing portion 313 is an outermost surface of the sleeve 31, that is, is farthest from the center axis J1 and includes a first cylindrical surface 3132 and a second cylindrical surface 3133 below the first cylindrical surface 3132. The first and second cylindrical surfaces 3132 and 3133 are adjacent to each other, as shown in FIG. 3, and are centered on the center axis J1. In this preferred embodiment, a distance of the second cylindrical surface 3133 from the center axis J1 is slightly larger than a distance of the first cylindrical surface 3132 from the center axis J1. Referring to FIG. 2, only the second cylindrical surface 3133 of the hub-fixing portion 313 of the sleeve 31 is in contact with the rotor hub 32. Other portions of the rotor portion 3, e.g., the first cylindrical surface 3132 are not in contact with the rotor hub 32.

In the sleeve 31, a printable region 100 where identifying information can be printed by the printing apparatus 5 of the component management system 4 (see FIG. 1) is arranged only on the first cylindrical surface 3132 of the outer side surface 3131 of the hub-fixing portion 313. In FIG. 3, the printable region 100 is shown as a region surrounded by broken line. In this preferred embodiment, the printable region 100 preferably has an axial height of about 2 mm and a circumferential width of about 4 mm, for example.

Referring to FIG. 2, the sleeve 31 is provided with an upper concave portion 3111 and a lower concave portion 3112 respectively formed above and below the shaft-insertion portion 311. The upper and lower concave portions 3111 and 3112 are approximately cylindrical, and each has an outer side surface of an inner diameter larger than an inner diameter of the shaft-insertion portion 311 in this preferred embodiment. In the upper and lower concave portions 3111 and 3112, the upper and lower projections 221 and 222 of the shaft 22 are accommodated, respectively. The shaft 22 is also provided with a reduced-diameter portion 223 at an approximately middle of the axial length of the shaft 22. The reduced-diameter portion 223 has a smaller outer diameter than other portions of the shaft 22 above and below the reduced-diameter portion 223. Thus, a gap between the outer side surface of the reduced-diameter portion 223 of the shaft 22 and the inner side surface of the shaft-insertion portion 311 of the sleeve 31 is larger than gaps between the outer side surface of the portions of the shaft 22 other than the reduced-diameter portion 223 and the inner side surface of the shaft-insertion portion 311.

In the motor 1, small gaps are provided above the reduced-diameter portion 223 of the shaft 22 between the outer side surface of the shaft 22 and the inner side surface of the shaft-insertion portion 311, between a bottom surface of the upper projection 221 of the shaft 22 and an inner bottom surface of the upper concave portion 3111 of the sleeve 31, and between an outer side surface of the upper projection 221 and an inner side surface of the upper concave portion 3111. Those small gaps are filled with lubricant. Similarly, small gaps are provided below the reduced-diameter portion 223 of the shaft 22 between the outer side surface of the shaft 22 and the inner side surface of the shaft-insertion portion 311, between a top surface of the lower projection 222 and an inner bottom surface of the lower concave portion 3112, and between an outer side surface of the lower projection 222 and an inner side surface of the lower concave portion 3112. Those small gaps are also filled with lubricant.

In the motor 1, the rotor hub 32 rotates together with the sleeve 31 about the center axis J1. This rotation generates a hydrodynamic pressure in the lubricant retained in the aforementioned gaps between the shaft 22 and the sleeve 31. Due to the hydrodynamic pressure, the stationary portion 2 supports the rotor portion 3 via the lubricant in a non-contact manner. In other words, the shaft 22, the sleeve 31, and the lubricant therebetween form a hydrodynamic bearing in the motor 1.

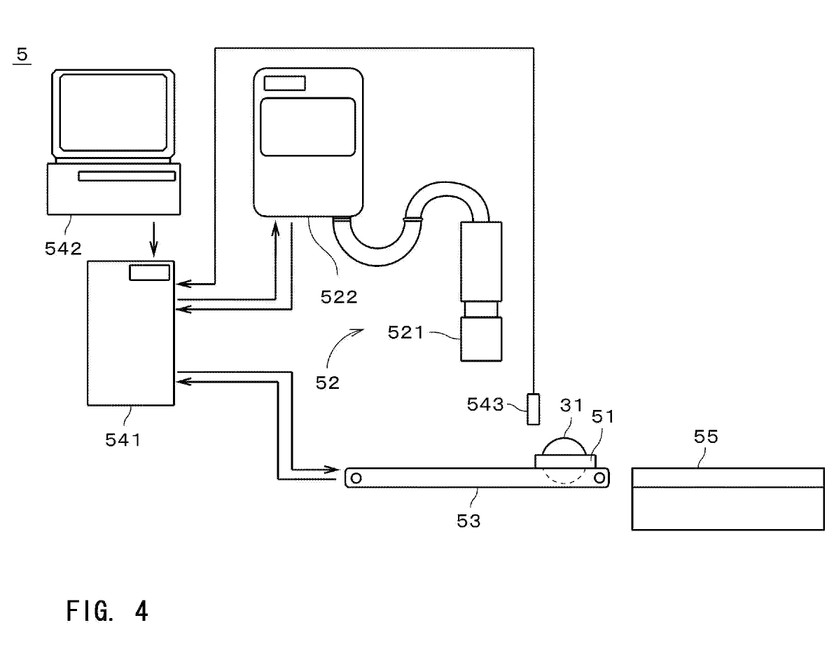

FIG. 4 illustrates the printing apparatus 5 of the component management system 4 according to the first preferred embodiment of the present invention. The printing apparatus 5 prints identifying information used for identifying a corresponding motor component onto the printable region 100 of the sleeve 31. In this preferred embodiment, the printing apparatus 5 performs printing by a known ink-jet technique, for example. Referring to FIG. 4, the printing apparatus 5 includes: a jig 51 for holding the sleeve 31; a printer 52 for discharging ink droplets toward the printable region 100 on the sleeve 31; a jig moving unit 53 which can move the jig 51 with the sleeve 31 held by the jig 51 relative to the printer 52; a control unit 541 controlling the printer 52 and the jig moving unit 53; a data input device 542 as a terminal via which data to be sent to the control unit 541 is input; and a sensor 543 which can detect the position of the jig 51. In this preferred embodiment, the jig moving unit 52 moves the jig 51 and the sleeve 31 to the left in FIG. 4, for example.

In this preferred embodiment, the printer 52 includes a printing head 521 which discharges ink droplets toward the printable region 100 on the sleeve 31, and a printer body 522 which supplies ink to the printing head 521. In the printing apparatus 5, a distance between the printing head 521 and the sleeve 31 held by the jig 51 in a vertical direction in FIG. 4 is set to millimeters to tens of millimeters, for example. Examples of ink which can be used are MEK (methyl ethyl ketone)-based ink, alcohol-based ink, and aqueous ink. In this preferred embodiment, the printer 52 uses quick-drying MEK-based ink. Examples of the identifying information printed on the printable region 100 of the sleeve 31 are two-dimensional codes including matrix-type two-dimensional codes, e.g., Veri code, QR code (registered trademark), Maxi code, and Data Matrix, and stack-type two-dimensional codes. The identifying information typically represented by the two-dimensional codes as described above contain information indicating an identifying number for distinguishing a corresponding sleeve 31 from other sleeves 31, and information on date and time of manufacture, for example. Those pieces of information are sent to the control unit 541 via the data input device 542 prior to printing, and are stored in the control unit 541.

The printing apparatus 5 also includes a heating plate 55 arranged to be adjacent to the jig 53. In the printing apparatus 5, a sleeve 31 which is to be subjected to printing is first placed on the heating plate 55 before printing, thereby being entirely heated. That is, not only the printable region 100 of the sleeve 31 but also the remaining regions are heated. It is preferable that the sleeve 31 be heated at a temperature in a range from approximately 40° C. to approximately 140° C., for example. More preferably, the sleeve 31 is heated at a temperature in a range from approximately 60° C. to approximately 80° C., for example. In this preferred embodiment, a plurality of sleeve 31 are placed and heated on the heating plate 55 at the same time, although they are not shown on the heating plate 55 in FIG. 4.

The printing procedure is now described. First, a sleeve 31 heated by the heating plate 55 is placed and held on the jig 51. Then, the jig moving unit 53 which is controlled by the control unit 541 transfers the jig 51 with the sleeve 31 held thereon to the left in FIG. 4. In response to the detection by the sensor 543 of passing of the jig 51 below the sensor 543, the control unit 541 controls the printer 52 to discharge ink droplets from the printing head 521 toward the printable region 100 of the sleeve 31 on the jig 51. The discharge direction of ink from the printing head 521 is controlled in the printing apparatus 5. More specifically, the discharge direction is controlled such that ink droplets fall within the printable region 100 and move substantially parallel to the center axis J1 of the sleeve 31 in the printable region 100. In this manner, on that sleeve 31 is printed a portion of the two-dimensional code indicating the identifying information corresponding to that sleeve 31.

Then, the discharge of ink droplets from the printing head 521 is stopped. During a period in which the discharge of ink droplets is stopped, the jig 51 with the sleeve 31 held thereon is displaced by the jig moving unit 53 by a small distance to the left in FIG. 4. That is, the position where ink droplets from the printing head 521 reaches is displaced to the right in FIG. 4 relative to the printable region 100. Then, the discharge of ink droplets from the printing head 521 toward the printable region 100 starts again.

The discharge of ink droplets from the printing head 521 and the stop of the ink discharge (and displacement of the jig 51 during the period of the stop of the ink discharge) are alternately repeated until the two-dimensional code printed in the printable region 100 is completed. In this preferred embodiment, the temperature of the printable region 100 is higher than a room temperature because the printable region 100 has been heated prior to the printing. Thus, the ink droplets on the printable region 100 are more quickly dried as compared with a case where the printable region 100 is kept at a room temperature. In other words, the heating plate 55 serves as a drying acceleration portion which can accelerate drying of the ink droplets on the printable region 100.

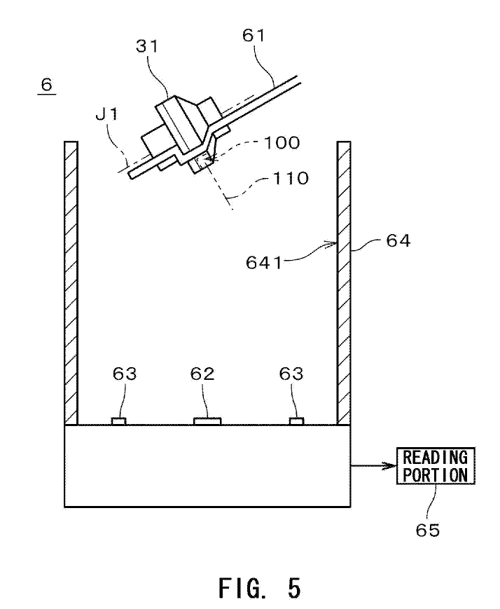

FIG. 5 illustrates an exemplary configuration of the reading apparatus 6 of the component management system 4 in this preferred embodiment. Referring to FIG. 5, the reading apparatus 6 includes a holding portion 61 which can hold a sleeve 31, an image-capturing device 62 which can capture an image of the printable region 100 of the sleeve 31 held on the holding portion 61 and output a signal corresponding to the captured image, a plurality of light sources 63 arranged in the vicinity of the image-capturing device 62, a reflecting portion 64 which reflects light from the light sources 63 toward the printable region 100 of the sleeve 31, and a reading portion 65 which receives the output signal from the image-capturing device 62 and acquires information contained in the two-dimensional code. In this preferred embodiment, the reflecting portion 64 is formed to be a hollow, approximately cylindrical member having an inner side surface 641 as a reflecting surface. FIG. 5 shows a cross section of the reflecting portion 64. In addition, although the number of the light sources 63 is not limited specifically, only two are shown in FIG. 5.

In this preferred embodiment, the holding portion 61 holds the sleeve 31 such that the center axis J1 of the sleeve 31 is at an angle to the horizontal direction and the printable region 100 faces downward, i.e., the printable region 100 faces the image-capturing device 62. More specifically, the image-capturing device 62 is arranged such that a line connecting the image-capturing device 62 and the center of the printable region 100 to each other is at an angle to a normal 110 (shown with two-dot chain line in FIG. 5) to the center of the printable region 100, i.e., a line intersecting with the center axis J1 at the center of the printable region 100 at a right angle. Also, the light sources 63 are arranged at such positions that a line connecting each light source 63 to the center of the printable region 100 is at an angle to the normal 110 to the center of the printable region 100.

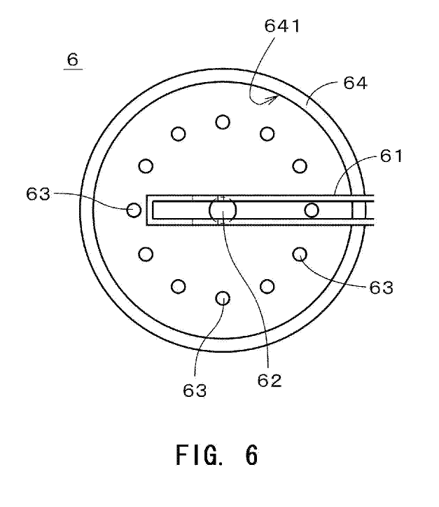

FIG. 6 is a plan view of the reading apparatus 6. In FIG. 6, the sleeve on the holding portion 61 is omitted although it is shown in FIG. 5. As shown in FIG. 6, the light sources 63 are circumferentially arranged about the image-capturing device 62 over the entire circumference of the circle centered on the image-capturing device 62 in this preferred embodiment. White LEDs (light-emitting diodes) are used as the light sources 63, for example. The light sources 63 are arranged with their optical axes substantially parallel to the vertical direction.

As shown in FIGS. 5 and 6, the reflecting portion 64 is arranged around the sleeve 31 held on the holding portion 61 and serves as a casing which can accommodate the image-capturing device 62 and the light sources 63 therein. The inner side surface 641 of the reflecting portion 64 reflects light from the light sources 63 as scattered light around the sleeve 31 (see FIG. 5). Although the entire inner side surface 641 can reflect light in this preferred embodiment, only a portion of the inner side surface 641 may be formed as a reflecting surface. In other words, it is only necessary that at least a portion of the inner side surface 641 of the reflecting portion 64 is reflective.

In the reading apparatus 6 of FIG. 5, light from the light sources 63 is reflected by the inner side surface 641 of the reflecting portion 64, so that the printable region 100 is irradiated with the reflected light. The image-capturing device 62, which has a focus slightly away from the printable region 100, captures an image of the printable region 100 from an oblique direction to the normal 110 of the printable region 100. That is, an image of the two-dimensional code on the printable region 100 is captured under indirect lighting.

Next, a procedure of management of sleeves performed by the component management system 4 is described. In the component management system 4 of this preferred embodiment (see FIG. 1), a plurality of sleeves are cleaned. For example, the sleeves are immersed in cleaning fluid stored in a cleaning bath and ultrasonic vibration is applied to the cleaning fluid. In this manner, the sleeves 31 are cleaned by ultrasonic cleaning.

The cleaned sleeves are then carried into the printing apparatus 5 shown in FIG. 4 and are placed on the heating plate 55 therein. The heating plate 55 heats the sleeves until the temperature of the sleeves reaches a predetermined temperature. Then, an operator picks up one sleeve 31 from the heated sleeves with a grasping tool, e.g., a pair of tweezers, and places it on the jig 51 such that its printable region 100 faces up, i.e., faces the printing head 521. When grasping the sleeve 31, the operator pays attention to bringing the grasping tool into contact with only the second cylindrical surface 3133 of the outer side surface 3131 of the hub-fixing portion 313 of the sleeve 31. Then, the discharge of ink droplets from the printing head 521, and the stop of ink discharge and displacement of the jig 51 during the period of the stop of ink discharge are alternately repeated. In this manner, a desired two-dimensional code is printed on the printable region 100 of the sleeve 31.

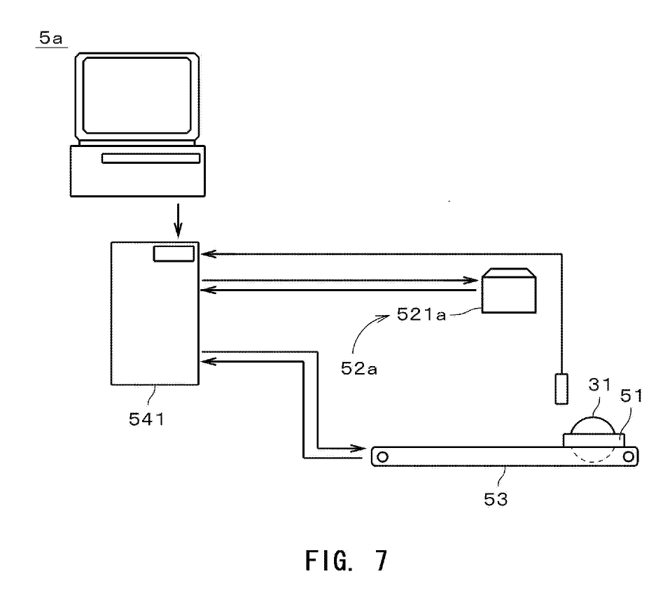

After the printing is completed, the sleeve 31 is grasped by the operator with the grasping tool. While being grasped, the sleeve 31 is carried out from the printing apparatus 5 and is then carried into the reading apparatus 6 shown in FIG. 5. In this carrying operation, the sleeve 31 is also grasped such that only the second surface 3133 of the hub-fixing portion 313 thereof is in contact with the grasping tool. Then, in the reading apparatus 6, the sleeve 31 is held by the holding portion 61 with its printable region 100 faces down, i.e., faces the image-capturing device 62. The image-capturing device 62 then captures an image of the two-dimensional code on the printable region 100 which is irradiated with scattered light. The captured image is sent to the reading portion 65 which in turn acquires at least one piece of information contained in the two-dimensional code, e.g., the identifying number and the date and time of manufacture of the sleeve 31 held on the holding portion 61. The thus acquired information is sent to the memory 7 shown in FIG. 7 and stored therein.

In the component management system 4 of this preferred embodiment, ultrasonic cleaning, heating, printing of two-dimensional codes, reading of two-dimensional codes, and storing of information contained in each two-dimensional code are successively performed for a plurality of sleeves. Based on the stored information, those sleeves are managed. In the component management system 4, a database is configured in which an identifying number of each sleeve corresponds to an identifying number of a bearing which is to incorporate that sleeve therein and/or an identifying number of a motor which is to incorporate that sleeve therein, for example, and the sleeves are individually managed based on the database. Accordingly, traceability of each sleeve can be improved.

In the case of managing sleeves based on identifying information assigned to each sleeve, an operator may write the identifying information, e.g., an identifying number on the surface of each sleeve by hand with a permanent marker, for example, prior to assembling a bearing and then may read the identifying information by eyes and register it in the database. However, since the sleeves are small, this technique has a disadvantage that, because of a large curvature of the surface of each sleeve, it is very difficult for the operator to write a character or the like on the sleeve's surface by hand. Also, such a writing operation requires a lot of time and effort. Moreover, since writing of identifying information on each sleeve and input of the read identifying information into the database are manually carried out, writing and inputting errors may be caused. In other words, there is a limit to improvement of management accuracy.

On the other hand, in the component management system of this preferred embodiment, at least one of the printing head 521 and the printable region 100 of the sleeve 31 is displaced relative to the other by the jig moving unit 53 in the printing apparatus 5. Also, the discharge direction of ink droplets from the printing head 521 is controlled. Thus, the position where the ink droplets from the printing head 521 reach is relatively displaced in the printable region 100 so that a two-dimensional code is printed on the printable region 100. In this manner, the two-dimensional code can be quickly and accurately printed on the printable region 100 provided on the surface of the sleeve 31 which is curved and made of metal. That is, various pieces of information such as identifying information can be quickly and accurately assigned to the sleeves 31.

In the reading apparatus 6, while the printable region 100 of the sleeve 31 is irradiated with scattered light, an image of the printable region 100 is captured from an oblique direction to the normal 110 to the center of the printable region 100. In this manner, the two-dimensional code on the printable region 100 is read. According to this reading technique, it is possible to accurately read the two-dimensional code printed on the printable region 100 with reducing halation caused by excessive light.

In the component management system 4 of this preferred embodiment, a two-dimensional code containing identifying information is quickly and accurately printed on each sleeve 31 by the printing apparatus 5, the two-dimensional code on each sleeve 31 is read by the reading apparatus 6 with high accuracy, and the sleeves 31 are managed based on the output of the reading apparatus 6 stored in the memory 7, as described above. Thus, the quality of sleeve management can be improved. Moreover, the two-dimensional code can be quickly printed and read by the printing apparatus 5 and the reading apparatus 6 in the component management system 4 of this preferred embodiment, respectively. Thus, productivity of the motors 1 can be improved.

In addition, in this preferred embodiment, the printing and reading of the two-dimensional code can be rapidly carried out by the component management system 4 during successively performed operations. Accordingly, troubles which may be caused when those operations are performed over a prolonged period of time can be prevented, thus preventing lowering of the quality of the motors 1.

In the printing apparatus 5 of this preferred embodiment, the printable region 100 of the sleeve 31 is heated by the heating plate 5 prior to the printing of the two-dimensional code on the printable region 100. Thus, ink droplets which have reached the printable region 100 can be quickly dried, thereby preventing ink from bleeding on the printable region 100 and enabling printing with high precision. Moreover, due to the heating of the printable region 100, dye or pigment in ink can be firmly fixed on the printable region 100, so that durability and resistivity of the two-dimensional code against solvent can be improved. Especially in a system in which sleeves are cleaned prior to printing by the printing apparatus 5, like the component management system 4 of this preferred embodiment, ink can easily bleed by effects of the cleaning. Also for this reason, it is preferable to accelerate drying of ink droplets on the printable region 100 by using the heating plate 55 in the printing apparatus 5.

Preferably, the heating plate 55 is set to heat the printable region 100 of the sleeve 31 to a temperature equal to or higher than approximately 40° C., for example. In this case, it is possible to prevent ink from bleeding on the printable region 100 more surely, resulting in high-precision printing. Moreover, when the heating temperature of the printable region 100 of the sleeve 31 is set to be equal to or lower than approximately 140° C., an evaporation rate of solvent in ink droplets on the printable region 100 can be prevented from becoming excessively larger. Accordingly, inferior fixing of dye or pigment at the position where ink droplets reach (which causes a defective two-dimensional code) can be prevented, resulting in high-precision printing.

As described above, high-precision printing by the printing apparatus 5 can be performed in the component management system 4 of this preferred embodiment. Thus, it is possible to prevent a reading error when the two-dimensional code is read by the reading apparatus 6. Accordingly, the quality of management of sleeves 31 can be improved more.

Since sleeves 31 are small motor-components and their surfaces have a large curvature, it is difficult to provide a large printable region on their surfaces. In this preferred embodiment, identifying information for identifying each sleeve 31 is printed preferably in the form of a two-dimensional code on the printable region 100 in the printing apparatus 5. Thus, as compared with a case where identifying information in the form of a one-dimensional code, numbers, or the like is printed, an area occupied by the printed identifying information can be made smaller. For this reason, the printing apparatus 5 of this preferred embodiment is suitable especially for small-sized motor components, e.g., sleeves 31.

As described above, since the printable region 100 is provided on the outer side surface 3131 of the hub-fixing portion 313 of the sleeve 31, that is, in a portion of the outermost surface of the sleeve 31 which has the smallest radius of curvature. This can make the printing of the two-dimensional code on the printable region 100 easier. Moreover, the reading of the two-dimensional code by the reading apparatus 6 can be also made easier by providing the printable region 100 on the outer side surface 3131.

The printable region 100 is arranged only on the first surface 3132 of the outer side surface 3131 of the hub-fixing portion 313. As described above, the first cylindrical surface 3132 is located slightly inside the second cylindrical surface 3133 in the radial direction, that is, is closer to the center axis J1 than the second cylindrical surface 3133. Therefore, when a sleeve 31 is carried out from the printing apparatus 5, the grasping tool for grasping the sleeve 31 cannot be come into contact with the two-dimensional code on the printable region 100 of the sleeve 31. Thus, the printed two-dimensional code can be prevented from being damaged.

In the reading apparatus 6, the reflecting portion 64 has an approximately cylindrical reflecting surface arranged around the sleeve 31 in this preferred embodiment. With this configuration, the printable region 100 can be illuminated with scattered light uniformly. Thus, halation which may occur on the printable region 100 can be efficiently reduced. Accordingly, the two-dimensional code on the printable region 100 can be read with high precision. Moreover, in this preferred embodiment, a plurality of light sources 63 are arranged over an entire circumference of a circle centered on the image-capturing device 62. This allows the printable region 100 to be more uniformly illuminated with scattered light. Furthermore, the reflecting portion 64 also serves as a casing for accommodating the image-capturing device 62 and the light sources 63 therein. This configuration contributes to size reduction of the reading apparatus 6.

### Second Preferred Embodiment

A printing apparatus in a component management system according to a second preferred embodiment is now described. FIG. 7 is a plan view of the printing apparatus 5a in the component management system of the second preferred embodiment. As shown in FIG. 7, the printing apparatus 5a does not include the printer 52 which performs printing in accordance with an ink-jet technique, shown in FIG. 4, but includes a laser marker 52a having a head 521a which can emit laser light to the sleeve 31 held on the jig 51. On the sleeve 31, a two-dimensional code is preferably printed by laser marking. Moreover, the printing apparatus 5a does not include the heating plate 55 shown in FIG. 4. Except for the above, the component management system of the second preferred embodiment preferably is substantially the same as that of the first preferred embodiment. Therefore, like parts are given to like reference numerals and the description thereof is omitted.

In the printing apparatus 5a, the jig moving unit 53 moves at least one of the head 521a and the printable region 100 of the sleeve 31 relative to the other, as in the first preferred embodiment. The control unit 541 controls the jig moving unit 53. An emitting direction of laser light from the head 521a is controlled. Thus, a two-dimensional code is printed within the printable region 100 by moving the position in the printable region 100, onto which laser light is emitted. In this manner, the two-dimensional code can be quickly and accurately printed on the printable region 100 of the surface of the sleeve 31 which is curved and made of metal. Accordingly, various pieces of information such as identifying information can be quickly and accurately assigned to sleeves 31, as in the first preferred embodiment.

In the printing apparatus 5a, the two-dimensional code is printed by laser marking as described above. Thus, durability of the two-dimensional code can be improved when it is printed by laser marking, as compared with a case where it is printed by ink-jet printing.

However, when the two-dimensional code is printed by ink-jet printing as in the first preferred embodiment, printing can be more rapidly at a reduced cost than laser marking. Thus, the ink-jet printing of the two-dimensional code can improve the productivity of motors 1 (see FIG. 2) and can reduce the manufacturing cost of the motors 1.

In the above description, preferred embodiments of the present invention have been described. However, the present invention is not limited thereto.

For example, in the first preferred embodiment, it is not necessary to arrange the heating plate 55 adjacent to the jig moving unit 53 in the printing apparatus 5. That is, the heating plate 55 may be arranged at an appropriate position in accordance with the operations performed in the printing apparatus 5 and the component management system 4.

In the printing apparatus 5, the sleeve 31 may be held by the jig 51 which has been heated in advance. With this configuration, heat transfer from the sleeve 31 to the jig 51 can be prevented or reduced. Thus, it is possible to surely prevent lowering of the temperature of the printable region 100 below a desired temperature, so that ink can be prevented from bleeding. Accordingly, high-precision printing can be performed.

In the printing apparatus 5, instead of the heating plate 55 for heating the sleeve 31 before printing, the jig 51 maybe provided with a heat source such that the sleeve 31 continues to be heated during and immediately after printing. In this case, the heat source of the jig 51 serves as a drying acceleration portion which can accelerate drying of ink droplets on the printable region 100. Moreover, the sleeve 31 may be heated before, during, and immediately after printing.

In the above preferred embodiments, the printable region 100 of the sleeve 31 is heated before printing in the printing apparatus 5, so that drying of ink droplets can be accelerated. In this case, it is not necessary to heat the entire sleeve 31. Alternatively, only the printable region 100 and a portion near the printable region 100 may be heated by, for example, radiation heat from a heater arranged near the printable region 100 so as to accelerate drying of ink droplets. Alternatively, an air sending portion may be provided as a drying acceleration portion, which can send an airflow toward the printable region 100 immediately after printing, so that drying of ink droplets can be accelerated.

The printable region 100 may not be only on the first cylindrical surface 3132 of the hub-fixing portion 313. In this case, the printable region 100 may be arranged on both the first and second cylindrical surfaces 3132 and 3133. Moreover, it is not necessary that the printable region 100 be provided only on the outer side surface 3131 of the hub-fixing portion 313. For example, the printable region 100 may be provided on both the outer side surface 3131 of the hub-fixing portion 313 and another portion adjacent thereto, e.g., the upper surface of the flange portion 312. That is, it is only necessary that the printable region 100 be provided on the outermost surface of the sleeve 31, i.e., the outer side surface 3131 of the hub-fixing portion 313. With this configuration, it is possible to make the radius of curvature of the printable region 100 as small as possible. Also, the printing of the two-dimensional code by the printing apparatus and the reading of the two-dimensional code by the reading apparatus can be performed more easily.

If a relatively large printable region can be ensured, the printing apparatus may print a character string composed of numerals and/or alphabets, a pattern such as a one-dimensional code, or the like on the sleeve 31, instead of the two-dimensional code.

In the component management system 4 of the first preferred embodiment, sleeves 31 may not be cleaned, or a process for reducing or preventing bleeding of ink may be performed for the surface of each sleeve 31 after cleaning. In this case, heating of the printable region 100 by the heating plate 55, i.e., drying acceleration of ink droplets on the printable region 100 can be omitted, as long as the bleeding of ink can be reduced to an acceptable level, i.e., a such a level that the reading apparatus 6 can read printed information.

In the component management system of the aforementioned preferred embodiments, identifying information may be printed on the curved surface of each of metal motor components other than sleeves 31, such as the shaft 22 (see FIG. 2) as a bearing component and other components. Moreover, the printable region may be provided on a flat metal surface of a motor component, which is formed by removing a portion of the curved surface of the motor component by cutting or the like, for example, and identifying information may be printed on that printable region.

The aforementioned printing apparatus is not necessarily used together with the reading apparatus 6 in the component management system 4. That is, the aforementioned printing apparatus may be used alone. Similarly, the aforementioned reading apparatus may be used alone.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method for printing identifying information on a motor component having a metal surface, comprising the steps of:
holding the motor component;
discharging ink from a printing head toward a printable region on the metal surface of the motor component; and
relatively displacing a position at which the ink is applied within the printable region by moving at least one of the motor component and the printing head.

2. The method as set forth in claim 1, wherein the discharging of the ink and the relatively displacing of the position are repeated until the identifying information is entirely printed on the printable region.

3. The method as set forth in claim 2, wherein the metal surface of the motor component is curved.

4. The method as set forth in claim 2, wherein the identifying information is a two-dimensional code.

5. The method as set forth in claim 2, wherein the printable region is arranged on an outermost surface of the motor component.

6. The method as set forth in claim 5, wherein the outermost surface of the motor component includes a first portion and a second portion which are both centered about a center axis of the motor component and are connected to each other, a distance of the second portion from the center axis being slightly larger than a distance of the first portion, and the printable region is arranged on only the first portion.

7. The method as set forth in claim 1, further comprising the step of accelerating drying of the ink on the printable region.

8. The method as set forth in claim 7, wherein the step of accelerating drying of the ink includes the step of heating the printable region.

9. The method as set forth in claim 8, wherein in the step of heating the printable region, the printable region is heated at a temperature in a range from approximately 40° C. to approximately 140° C.

10. A method for forming identifying information on a motor component having a metal surface, comprising:
holding the motor component;
emitting light from a head to a printable region arranged on the metal surface of the motor component so as to form identifying information in the identifying information region; and
relatively displacing a position at which the light is applied within the printable region by moving at least one of the motor component and the head.

11. The method as set forth in claim 10, wherein the emitting of the light and the relatively displacing of the position are repeated until the identifying information is entirely printed on the printable region.

12. The method as set forth in claim 11, wherein the metal surface of the motor component is curved.

13. The method as set forth in claim 11, wherein the identifying information is a two-dimensional code.

14. The method as set forth in claim 11, wherein the printable region is arranged on an outermost surface of the motor component.

15. The method as set forth in claim 14, wherein the outermost surface of the motor component includes a first portion and a second portion which are both centered about a center axis of the motor component and are connected to each other, a distance of the second portion from the center axis being slightly larger than a distance of the first portion, and the printable region is arranged on only the first portion.

16. A method for reading identifying information located on a motor component having a metal surface, the method comprising the steps of:
holding the motor component;
irradiating an identifying information region arranged on the metal surface of the motor component with light from an oblique direction with respect to a normal to a center of the printable region;
capturing an image of the identifying information region using an image-capturing device arranged such that a line connecting an approximate center of the identifying information region to the image-capturing device is at an angle relative to the normal to the center of the identifying information region; and
acquiring the identifying information based on an output of the image-capturing device.

17. The method as set forth in claim 16, wherein the light with which the identifying information region is irradiated is emitted from a plurality of light sources arranged such that a line connecting the center of the identifying information region to each of the light sources is at an angle relative to the normal to the center of the printable region, and is then reflected by a reflecting portion toward the printable region.

18. The method as set forth in claim 16, wherein the metal surface of the motor component is curved.

19. The method as set forth in claim 17, wherein the light emitted from the plurality of light sources is reflected and scattered by an approximately cylindrical reflecting surface of the reflecting portion, the reflecting surface being arranged around the motor component.

20. The method as set forth in claim 19, wherein the reflecting portion is an approximately cylindrical casing accommodating the image-capturing device and the light sources therein, and an inner side surface of the reflecting portion includes a reflective portion defining the reflecting surface.

21. The method as set forth in claim 17, wherein the light sources are arranged about the image-capturing device over an entire circumference thereof.

22. A method for managing a motor component having a metal surface, the method comprising the steps of:
holding the motor component;
printing identifying information on a printable region arranged on the metal surface of the motor component by discharging ink from a printing head toward the printable region and relatively displacing a position at which the ink reaches within the printable region by moving one of the motor component and the printing head relative to the other;
reading the identifying information on the motor component by the method as set forth in claim 16; and
cleaning the motor component prior to the printing of the identifying information.

23. A method for managing a motor component having a metal surface, comprising:
holding the motor component;
printing identifying information on a printable region arranged on the metal surface of the motor component by irradiating the printable region with light from an oblique direction with respect to a normal to a center of the printable region, and relatively displacing a position emitted by the light within the printable region by moving one of the motor component and a light source relative to the other;
reading the identifying information on the motor component by the method as set forth in claim 16; and
cleaning the motor component prior to the printing of the identifying information.
